(19) United States
(12) Patent Application Publication
(10) Pub. No.: US 2017/0316524 A1
(43) Pub. Date: Nov. 2, 2017

(54) A METHOD AND SYSTEM FOR MANAGING A TRIP

(71) Applicant: Manage Your Trip Ltd., Netanya (IL)

(72) Inventors: Raphael AMZALLAG, Netanya (IL); Yossef AMZALLAG, Netanya (IL)

(21) Appl. No.: 15/522,086

(22) PCT Filed: Oct. 9, 2015
(86) PCT No.: PCT/IL2015/051010

§ 371 Date: Apr. 26, 2017

(30) Foreign Application Priority Data
Nov. 26, 2014 (IL) 235931

(51) Int. Cl. G06Q 50/14; G06Q 20/10; G06Q 30/06; G06Q 50/26

(52) U.S. Cl. CPC G06Q 50/14; G06Q 50/265; G06Q 20/10; G06Q 30/0611

(57) ABSTRACT

The present invention relates to a system for planning a group trip comprising: (a) a module for loading parameters; (b) a database for storing details of suppliers; (c) communication means for communicating with suppliers; and (d) processing means capable of: processing parameters from said module, scanning said database of suppliers, communicating with suppliers using said communication means, and providing at least one trip plan, for a group trip.

### TECHNICAL FIELD

The present invention relates to tourist trips management. More particularly, the present invention relates to online planning and managing tourist group trips.

### BACKGROUND

The use of online services to make travel arrangements, are well known and widely used today. However, currently available online services are directed primarily to individual travelers. The currently available online services thus do not adequately address the complicated needs and requirements of group travel.

In addition today's online travel sites allow a user to search and book travel arrangements for transportation and lodging for a single tourist from one originating point to another point. Today's online tools are optimized for single point to single point travel, which does not fulfil the needs of a group travel.

US 2004/148207 discloses a method to plan a trip, at a travel service site, establishing a homepage for the trip; contacting, such as by emailing, potential trip participants from the travel service site for informing them of the existence of the trip homepage; and making travel arrangements related to the trip by using tools provided to the potential trip participants at the trip homepage. The travel arrangements may include arranging payment for the trip, and/or arranging accommodations during the trip. The travel arrangements may also include determining which trip participants will share lodging accommodations during the trip.

US 2006/206363 describes a software tool that optimizes group travel. The described invention enables a user to search, optimize, synchronize, coordinate and book travel for Lodging and Transportation for multiple people from multiple locations around the country/globe to a single destination or series of destinations. The search and planning software tool allows one user to plan and query a group trip in one click which returns a summarized group trip itinerary along with each group member individual itinerary. The described engine can be used to select destinations, dates of travel, lodging, transportation modes representing air, bus, train, automotive travel and routes for each based on group member locations, “True Time of Travel” relative to value of time, and optimization preferences such as lowest total cost of the trip, “maximize the amount of time group members spend together at group budget”, or shortest total travel time. The disclosed coordination engine allows the trip for all members to be coordinated in one place with the ability to hold reservation, auto/systemic confirmation of each individual, book reservation, choose costing methods, negotiate changes, and communicate with trip members.

It would therefore be desired to propose a system void of these deficiencies.

### SUMMARY

It is an object of the present invention to provide a method for planning tourist trips.

It is another object of the present invention to provide a method for bidding supplies to tourist group trips.

It is still another object of the present invention to provide a method for optimizing costs of group trips.

It is still another object of the present invention to provide a method for managing a tourist group during a trip.

Other objects and advantages of the invention will become apparent as the description proceeds.

The present invention relates to a method for planning a group trip, comprising the steps of: (a) loading the parameters, related to said group trip, to the module; (b) analyzing said parameters, related to said group trip, and deducing at least one category of the required supplies and the respective quantity for said group trip; (c) scanning the DB of suppliers and selecting the relevant suppliers capable of supplying said required supplies for said group trip; (d) inviting at least two suppliers of said selected suppliers to bid for supplying said required supplies for said group trip; (e) receiving at least two bids, from said suppliers, for supplying said required supplies; (f) selecting at least one preferred bid, from said received bids of said suppliers; and (g) providing at least one trip plan, for a group trip, based on at least one of said preferred bids and its respective supplier.

Preferably, the invention further comprises the step of creating a group profile based on the participant of the group.

In one embodiment, the invention further comprises the step of adding another participant to the group trip.

In one embodiment, the invention further comprises the step of managing a crisis in real time.

In one embodiment, the invention further comprises the step of managing a crisis in real time based on the group profile.

In one embodiment, the invention further comprises the step of communicating information about the crisis in real time to the planner of the group trip.

The present invention also relates to a system for planning a group trip comprising: (a) a module for loading parameters; (b) a Database for storing details of suppliers; (c) communication means for communicating with suppliers; and (d) processing means capable of processing parameters from said module, scanning said DB of suppliers, communicating with suppliers using said communication means, and providing at least one trip plan, for a group trip.

Preferably, the system further comprises means for receiving payments.

Preferably, the system further comprises means for communicating with the travelers of the group.

Preferably, the system further comprises GPS means for reporting in real time the location of the group during the group trip

### BRIEF DESCRIPTION OF THE DRAWINGS

The accompanying drawings, and specific references to their details, are herein used, by way of example only, to illustratively describe some of the embodiments of the invention.

In the drawings:

FIG. 1 is a schematic diagram, of the system for planning and managing group trips, according to one embodiment.

FIG. 2 is a more detailed schematic diagram, of the system for planning and managing group trips, according to one embodiment.

### DETAILED DESCRIPTION

For the sake of brevity the following terms are defined herein:

Station—a location, accessible free of charge, for a group of travelers and/or individual travelers.

Attraction—a location or an operation, accessible for a charge, for a group of travelers and/or individual travelers.

Road Map—a series of stations and/or attraction that may be planned for one day. In some cases the road map may be built as a skeleton of a day and used several times.

Excursion day—an entity comprising a Road Map and additional information such as lodging, food or travel time information, etc. on a selected date in the calendar. The excursion day may have a full timeline which comprises a road map skeleton and the additional information specifically for that day such as lodging, food or travel time information, etc.

Trip—a series of excursion days. A trip must have at least one excursion day.

Supplies—services or products for the travelers of a trip.

Suppliers—providers of supplies.

As of today the “group trip” industry relays on a number of service providers which interlink together for producing a group trip. For example, when a traveler wishes to create a group trip for a number of his friends, which share a common interest, or alternatively, join a group trip of his liking, he typically contacts a Travel Agency (TA). The TA may then typically contact a Tour Operator (TO) who specializes in planning and selling tourism packages to a single traveler or to a group of travelers. The TO may then contact a Destination Management Company (DMC), which may be a local receptive service, or a company that researches, develops and refines creative and unique itineraries which include, inter alia, attractions and/or stations that are located in their area. Typically, the DMCs actively develop a relationship with the suppliers in their areas and are constantly in touch with a pool of TOs to promote and sell the packages they are planning. These tourism packages may include simple packages like flying tickets or they may include complex packages comprising several weeks of itineraries in a given area. Once the DMC have planned and built a trip package it may then be sold to a TO which sells it to a TA which can then provide it to a traveler or group of travelers. In some cases the DMC initiates and plans and builds a certain group trip after which it tries to promote it to the TOs and the TAs for selling to the travelers.

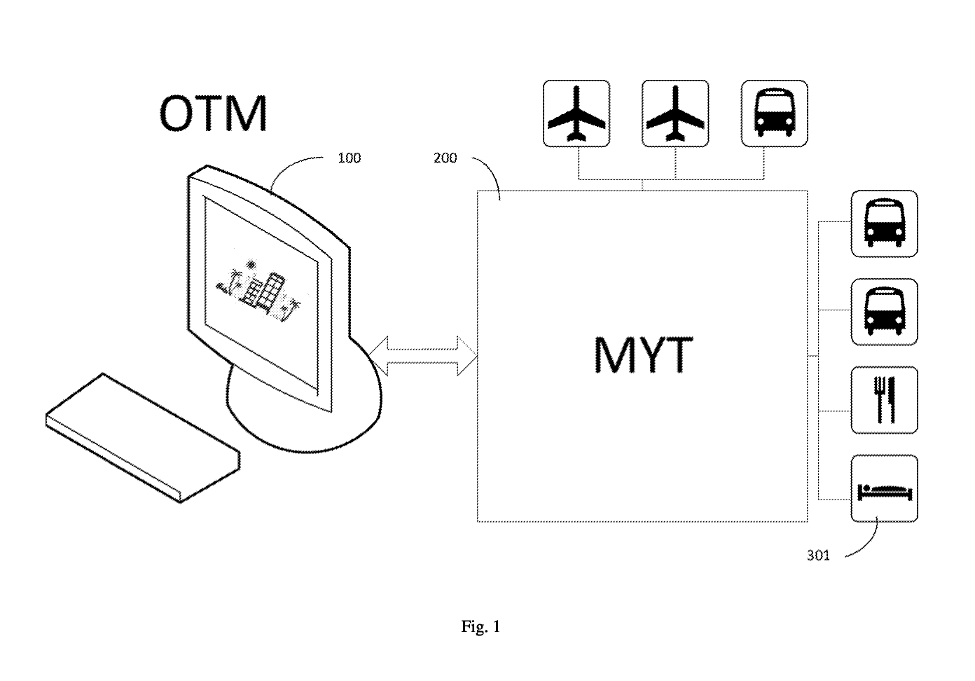

FIG. 1 is a schematic diagram, of the system for planning and managing group trips, according to one embodiment. In one embodiment a “group trip” may include more than 1 traveler. In another embodiment a “group trip” may include more than 9 travelers. In yet another embodiment a “group trip” may include more than 20 travelers. The Organized Tourism Manager (OTM) 100 is a user that may use the Manage Your Trip (MYT) 200 system to plan, create, publish and/or manage trips. The OTM 100 may connect to the MYT 200 system using any known communication means, such as the Internet. Once the OTM 100 has planned a trip he may be able to offer his planned trips to a filtered group of resellers or directly to a filtered group of travelers using his own records. The OTM 100 may be a DMC, a TO or even TA who has decided to expend his activities. The MYT 200 system may also be connected to a number of suppliers, such as a hotel supplier 301 which supplies lodging arrangements, or to any other suppliers which can supply trip needs. Thus the MYT 200 is a system that may be used permanently, as a single platform, for planning and organizing group trips based on demands from OTMs and supplies from suppliers.

In one embodiment, the system may be used for optimizing the costs involved with group trips. For example, if an OTM 100, as described in relations to FIG. 1, wishes to plan a group trip, he may build the time line of a trip by loading the parameters of the group trip to the MYT 200 module. The module may include an Internet site, a mobile device application, or any other computerized application capable of receiving data from an OTM 100 user. Examples of parameters of a group trip may be the requested area of the trip, the number of participants in the group, the number of days of the trip, the requested total cost of the trip, or the trip motive etc. Once the parameters have been loaded to the module of the MYT 200, the MYT 200 system may then analyze these loaded parameters of the group trip and deduce the categories of that trip, their respective required supplies, and the supplies' respective quantities. In one embodiment, the module may comprise a fixed minimal number of categories, where the OTM 100 user may enter his preferences according to the set categories. Thus the MYT 200 system may deduce the needed categories of that trip based on the preferences of the OTM 100 user. For example, if the OTM 100 user enters that he plans a trip of 2 excursion days for a group of 100 participants, and they will need no insurance, the group trip will need in the category of food—600 meals, in the category of travel—2 buses, in the category of lodging—50 hotel rooms, etc. In some embodiments, the categories may be divided into subcategories such as warm meals, sandwiches etc. for the category of food.

Once the categories and their respective required supplies have been determined, the MYT system may then scan its database (DB) of suppliers and select the relevant suppliers capable of supplying the required supplies in the required quantities for the group trip. Relevant suppliers may be any supplier which may be able to supply the required supplies. The MYT system may then send invitations to some or all of the selected suppliers to bid for supplying the required supplies for the group trip. For example, a number of caterers may be contacted and invited to bid their price for providing 600 meals. In one embodiment, the bidding process may be more complicated and may require the suppliers to bid for a preselected menu or a preselected type list menu. In one embodiment, only suppliers capable of supplying a certain standard of food may participate in the bid.

Once the bids, from the suppliers, have been received, the MYT system may then select at least one preferred bid for each category. In one embodiment the cheapest bid is selected. In another embodiment, other factors may be taken into account such as popularity, specific needs of the group, etc. Once at least one bid has been selected for each category the MYT system may then aggregate the bids into one trip plan and provide that trip plan to the OTM user. In one embodiment the MYT system provides a number of trip plans to the OTM user. In one embodiment the MYT system may provide one or more trip plans with a number of alternatives for some or all of the categories.

In one embodiment The bidding may be open and other suppliers which are not stored on the DB of the MYT system may be allowed to bid as well.

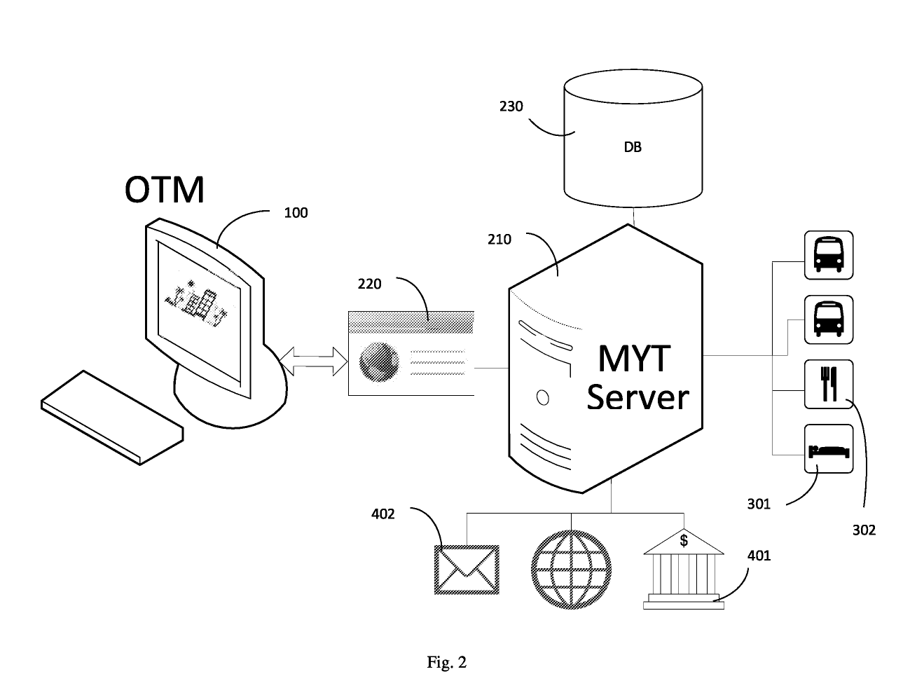

FIG. 2 is a more detailed schematic diagram, of the system for planning and managing group trips, according to one embodiment. As described in relations to FIG. 1, the OTM 100 is a user having a computer or any other processing unit and may communicate and use the MYT system to plan, create, publish and/or manage trips. For example, if an OTM 100, wishes to plan a group trip, he may load the parameters of the group trip to the MYT module 220. Example parameters of the group trip may be number of days, number of participant, age range of participants, type of attractions and/or stations, region of the attraction and/or station required and price indicator either by day and/or by station and/or total or a combination thereof. The module 220 may be an Internet site, a mobile device application, or any other computerized application capable of receiving data from an OTM 100 user. The parameters received may be stored on the disk of Server 210, on a remote cloud, or on any other repository capable of storing data. MYT Server 210 may be any processing system such as a computer, a server, a mobile processing unit or any other system capable of processing data. The MYT Server 210 may process and analyze the loaded parameters of the group trip and deduce the required categories of the trip, the respective required supplies, and the supplies' respective quantities. The MYT Server 210 may scan its database (DB) 230 of suppliers and select the relevant suppliers capable of supplying the required supplies in the required quantities for the group trip. The DB 230 may be stored in the MYT Server 210 or stored in a different location. The MYT server 210 may also communicate with the selected suppliers such as suppliers 301 and 302, for inviting them to bid for supplying the required supplies for the group trip. For example, a number of caterers, as caterer 302, may be invited to bid their price for providing meals. The MYT Server 210 may also receive the bids, from the suppliers, and then select at least one preferred bid for each category. The MYT Server 210 may also communicate the trip plan comprising the selected bids to the OTM user 100.

The communication means of the MYT system may be any known wired or wireless communication means such as communication over the Internet, over a private net or using any other communication method.

In one embodiment, the MYT Server 210, as described in relations to FIG. 1, may also have means 401 for receiving payments from the participants of the group trip. In an embodiment, the MYT Server 210 may also have means 402 for sending email and communicating with the travelers of the group before the trip, during the trip and/or after the trip. In an embodiment the MYT Server 210 may have other capabilities such as advertising capabilities and may be connected to other entities such as promotion systems. In one embodiment, the communication flow, between the OTMs and suppliers, is managed by MYT system for other services, such as reservation and/or payment.

In one embodiment, an OTM may be able to add a new traveler directly to a list of participant of a specific group trip. In an embodiment, the traveler is offered to join a group based on his interests and the group interests.

In one embodiment, the MYT system may compile individual profile information of the travelers in a group and define a specific tourist profile on a given group. This group profile may evolve each time a new participant is inserted into the group because of the specific profile of this new participant. In one embodiment, the MYT system may receive feedbacks from the travelers of the group during the trip. Thus the group profile may also evolve due to the feedbacks that are given by the participant of this group during the trip.

In one embodiment the MYT system may be used for covering marketing aspects feedback from the field and back-office management, such as reservation follow-up, CRM, ERP, advertising, etc.

In one embodiment, a Remote GPS, installed on a device of a traveler, may be used to report in real time where the group is located to the OTM. Since this communication may drain the battery of the device, the GPS of the device may be used on a specific frequency of time when the MYT Guide App is on, such as every 10 minutes, according to an embodiment.

In one embodiment, a guide application may be provided for the guide of the group, in order to communicate information on each participant of the group and each supplier that are scheduled during the trip. The guide app may also be used to update the OTM regarding the position of the group(s) in real time and to manage special events like in an event of a crisis, such as when a planned attraction is not accessible. In an embodiment, some professional information on the trip may be available on the guide app.

In one embodiment, the MYT system may be used also during the trip, if one of the stations or attractions is all of the sudden unavailable. Thus the MYT system may find another attraction, or station, relevant for the trip and offer it as a substitute to the group trip instead. For example, the planning of a group trip may evolve around a common interest of motive such as water extreme sports or the like. Thus if one planned water attraction is found to be closed that day the system may offer another water attraction suited for the group instead. In another embodiment the substitute may be found within the initial bidding process. In another embodiment the MYT system may invite other suppliers to bid for a substitute attraction in real time.

In one embodiment, the MYT system may be able to see in real time any delay in the trip plan and send alerts toward the relevant suppliers and/or other relevant entities such as the OTM who planned the trip. The MYT system may also provide the OTM and/or to the guide an option to change some of the trip itineraries such as change stations in real time. In one embodiment, a bi-directional alert system may allow the suppliers to update in real time the MYT clients on a specifics issue.

In one embodiment, the system may be used for planning and/or managing group trips and their itineraries. For example, if an OTM 100, as described in relations to FIG. 1, knows with which suppliers he wishes to work he may use the system for planning a group trip without bids, or partially, with bids for only some of the categories. Thus the OTM 100 may build the time line of the group trip by selecting first a road map and then loading the parameters of the group trip to the MYT 200 module. Once the parameters have been loaded to the module of the MYT 200, the MYT 200 system may then analyze these loaded parameters of the group trip and deduce the categories of that trip, their respective required supplies, and the supplies' respective quantities. The MYT system may then send requests to the suppliers the OTM 100 has identified for supplying the group trip. Thus the MYT system may aggregate the suppliers into the trip plan and provide that trip plan to the OTM user, with the reservation for each supplier and the details of the required supplies. In one embodiment, the MYT 200 system may offer the OTM 100 user other options besides the suppliers he has identified for supplying the group trip.

While the above description discloses many embodiments and specifications of the invention, these were described by way of illustration and should not be construed as limitations on the scope of the invention. The described invention may be carried into practice with many modifications which are within the scope of the appended claims.

1. A method for planning a group trip comprising the steps of:
a. loading the parameters, related to said group trip, to the module;
b. analyzing said parameters, related to said group trip, and deducing at least one category of the required supplies and the respective quantity for said group trip;
c. scanning the database of suppliers and selecting the relevant suppliers capable of supplying said required supplies for said group trip;
d. inviting at least two suppliers of said selected suppliers to bid for supplying said required supplies for said group trip;
e. receiving at least two bids, from said suppliers, for supplying said required supplies;
f. selecting at least one preferred bid, from said received bids of said suppliers; and
g. providing at least one trip plan, for a group trip, based on at least one of said preferred bids and its respective supplier.

2. A method according to claim 1, further comprising the step of creating a group profile based on the participant of the group.

3. A method according to claim 1, further comprising the step of adding another participant to the group trip.

4. A method according to claim 1, further comprising the step of managing a crisis in real time.

5. A method according to claim 1, further comprising the step of managing a crisis in real time based on the group profile.

6. A method according to claim 4, further comprising the step of communicating information about the crisis in real time to the planner of the group trip.

7. A system for planning a group trip comprising:
a. a module for loading parameters;
b. a database for storing details of suppliers;
c. communication means for communicating with suppliers; and
d. processing means capable of processing parameters from said module, scanning said database of suppliers, communicating with suppliers using said communication means, and providing at least one trip plan, for a group trip.

8. A system according to claim 7 further comprising means for receiving payments.

9. A system according to claim 7 further comprising means for communicating with the travelers of the group.

10. A system according to claim 7 further comprising GPS means for reporting in real time the location of the group during the group trip.
